(19) United States
(12) Patent Application Publication
(10) Pub. No.: US 2009/0086694 A1
(43) Pub. Date: Apr. 2, 2009

(54) Multimedia communication gateway for hospitality and convention facilities

(76) Inventors: Hooman Honary, Woodland Hills, CA (US); Reza Majidi Ahi, Los Altos, CA (US)

Correspondence Address: DENNIS W. BEECH (LAW OFFICE OF DENNIS W. BEECH), P.O. BOX 519, MURRIETA, CA, 92564-0519, US

(21) Appl. No.: 12/214,374

(22) Filed: Jun. 18, 2008

Related U.S. Application Data
(60) Provisional application No. 60/934,974, filed on Jun. 18, 2007.

(51) Int. Cl. H04W 92/00

(52) U.S. Cl. 370/338

(57) ABSTRACT

The present invention may be used for interfacing disparate forms of communication media and networks in hospitality and convention facilities. A gateway unit that may be used in a guest room may have a front panel, a connector panel and at least one antenna. A computing device, multiple memory elements and communication interface elements may be interconnected in the gateway unit for communication sensors, controls, ports and antennas of the gateway unit. The gateway unit may include hub and router functional elements and may integrate the external and internal media and network system content for a user to interface user elements while in a guest room.

This application claims the benefit of U.S. Provisional Application No. 60/934,974, filed on Jun. 18, 2007.

### BACKGROUND OF THE INVENTION

This invention relates to systems for interfacing different or disparate forms of communication media and networks that may be communicating content such as entertainment, voice and date. The system may have a device in the form of a gateway for interconnecting disparate media and networks by processing various protocols that each media or network may use.

Access to multimedia communication systems in hospitality and convention facilities or rooms may currently be provided to guests by installation of independent autonomous ports or interface units that serve a particular purpose or type of communication link. As an example, connection to the World Wide Web may be provided by a telephone or cable link. Use of an in room display or television for video game play may be provided by a convenient connector attached to a wall or on furniture that may be connected to a display device. These connectors or links may be located at various places in a room.

The incentive for access to multimedia communication systems in such environments may relate to the competitive travel market wherein guest facilities may strive to differentiate themselves from competitors to improve financial performance. There may be little real advancement in the guest room of hospitality or convention facilities to attract the next generation of guests that may require or need new forms of service and connectivity to communication systems other than the providing of disparate autonomous connection links for some combination of such systems.

### SUMMARY OF THE INVENTION

The present invention is directed to systems for interfacing disparate forms of communication media and networks in hospitality and convention facilities. A gateway unit that may be used in a guest room may have a front panel, a connector panel and at least one antenna. A computing device, multiple memory elements and communication interface elements may be interconnected in the gateway unit for communication sensors, controls, ports and antennas of the gateway unit. The gateway unit may include hub and router functional elements and may integrate the external and internal media and network system content for a user to interface user elements while in a guest room.

These and other features, aspects and advantages of the present invention will become better understood with reference to the following drawings, description and claims.

### BRIEF DESCRIPTION OF THE DRAWINGS

FIG. 1 illustrates a functional diagram of a gateway and media according to an embodiment of the invention;

FIG. 2 illustrates a functional diagram of a gateway unit according to an embodiment of the invention.

### DETAILED DESCRIPTION

The following detailed description represents the best currently contemplated modes for carrying out the invention. The description is not to be taken in a limiting sense, but is made merely for the purpose of illustrating the general principles of the invention.

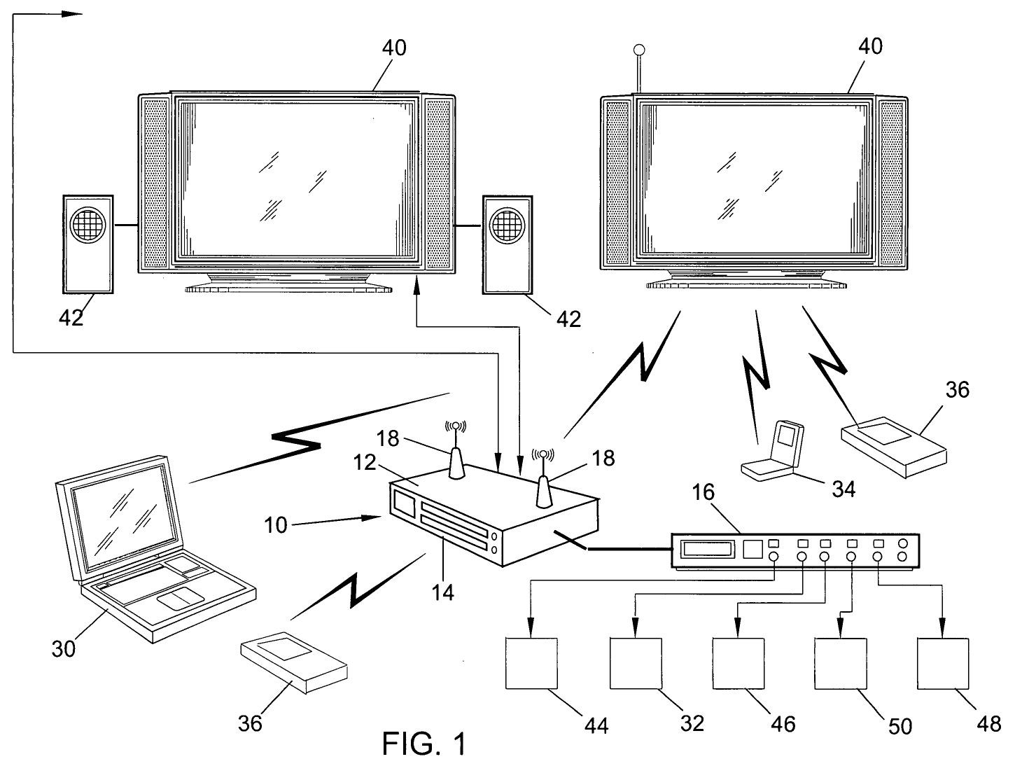

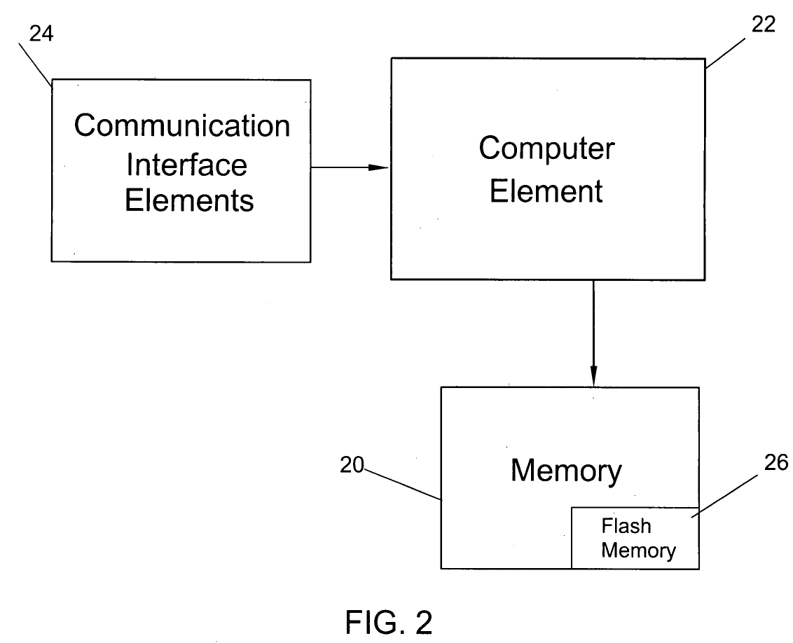

Referring to FIGS. 1 and 2, a multimedia communication gateway 10 may be packaged as a unit 12 or box with a front panel 14 having sensors and controls, a connector panel 16 that has multiple ports and may be a rear panel, antennas 18 and other elements, such as, power connectors, indicators and the like. The gateway 10 may provide a single element for use by a guest for all forms of media and networks coming into a guest room. In addition, the unit 12 may allow networking of media within a guest room, which may allow for new applications and services for additional revenue and improved guest experience.

The gateway may include the functions of a hub and a router for interfacing the external communication media linked into and out of a guest room that may be wired or wireless and the media communication within or internal to the guest room between elements within the room that may be wired or wireless. The external media may be wire or cable, Ethernet, coaxial and the like as well as wireless, cellular, WiFi and the like. The internal media may be from user devices such as laptop computers 30, electronic notebooks, audio recorder 32, cell phone 34 or other forms of portable or mobile devices. Internal media, may also include facilities supplied displays speakers 43, telephones 44, video conference equipment 46, game play devices 48, recording devices 50, and the like. Remote control units 36 may be used.

The gateway may have a computing type device such as a microprocessor, various types of memory, and multiple communication interfaces. The functional architecture may be designed for communication interfaces to be modularized such that the addition or removal of interfaces may be done without affecting other elements of the gateway. The gateway may also allow active element changes or hot swapping of interface elements. The types of memory may include flash memory to enable time shifting of media content to allow services such as monitoring or viewing of just missed content.

The gateway 10 may allow for seamless networking of disparate media forms of data and content within a guest room. The interior or in-room networking may enable a host of services in a room; and may allow sharing and communication of personal content or viewing and listening to personal content from a personal audio recorder, camcorder, or other source of personal content. The networking may facilitate multiplayer gaming in a guest room. The gateway 10 may allow multiple heterogeneous entertainment-on-demand sessions delivered to a guest room to view a movie and to listen to streamed music. Also, video-on-demand programs may be provided allowing different persons to view different content simultaneously.

The gateway 10 may allow seamless user interface for various services, devices and applications. The user may be insolated from the technology variations between different media and networking communication technologies to simply use the services and application.

While the invention has been particularly shown and described with respect to the illustrated embodiments thereof, it will be understood by those skilled in the art that the foregoing and other changes in form and details may be made therein without departing from the spirit and scope of the invention.

I claim:

1. A system for interfacing disparate forms of communication media and networks in hospitality and convention facilities comprising:
a gateway unit structured for use in a guest room that has a front panel with a plurality of sensors and controls, a connector panel with a plurality of ports, and at least one antenna;
a computing device, a plurality of memory elements, and a plurality of communication interface elements interconnected and in communication with said plurality of sensors and controls, said plurality of ports and said antenna; and
said gateway has a hub and a router functional element wherein the media and networking systems external to said guest room may be integrated, the media and networking system internal to said guest room may be integrated, and a user may interface with the external and internal media networking systems.

2. The systems as in claim 1 wherein said gateway unit has a modular architecture for ease of addition and removal of said communication interfaced elements.

3. The system as in claim 1 wherein said plurality of memory elements include a flash memory structured for time delayed monitoring of media content.

4. The system as in claim 1 wherein said external media and networking systems have at least one of a wire, a cable, a coaxial line, and an Ethernet line.

5. The system as in claim 1 wherein said external media and networking systems have at least one of a wireless link, a cellular link and a WiFi communication link.

6. The system as in claim 1 wherein said user interface is selected from the group consisting of a laptop computer, an electronic notebook, a personal user unit, and a cellular telephone.

7. The system as in claim 1 wherein said user interface is selected from of the group consisting of an electronic display, a speaker, a telephone, a video conference unit, and a game play device.

8. The system as in claim 1 wherein said computing device is a microprocessor.
